(19) United States
(12) Patent Application Publication
(10) Pub. No.: US 2013/0322783 A1
(43) Pub. Date: Dec. 5, 2013

(54) IMAGE COMPOSING APPARATUS OF AROUND VIEW MONITOR SYSTEM FOR CHANGING VIEW MODE EASILY AND METHOD THEREOF

(71) Applicant: HYUNDAI MOBIS CO., LTD., Yongin-si (KR)

(72) Inventor: Seok Tae KANG, Yongin-si (KR)

(73) Assignee: HYUNDAI MOBIS Co., Ltd., Yongin-si (KR)

(21) Appl. No.: 13/853,622

(22) Filed: Mar. 29, 2013

(30) Foreign Application Priority Data
Jun. 1, 2012 (KR) 10-2012-0059180

(51) Int. Cl. G06T 11/60

(52) U.S. Cl. CPC G06T 11/60
USPC 382/284

(57) ABSTRACT

Provided are an image composing apparatus of an around view monitor system for changing a view mode easily and a method thereof. According to the apparatus and method, images are composed by using a look up table including records in which color representation information or coordinate information of input images is recorded for each screen output pixel and the composed image is outputted to a display device. Accordingly, the view mode can be freely configured by changing the look up table without changing the design of image composing logic.

### CROSS-REFERENCE TO RELATED APPLICATIONS

This application claims priority under 35 U.S.C. §119 to Korean Patent Application No. 10-2012-0059180, filed on Jun. 1, 2012, the disclosure of which is incorporated herein by reference in its entirety.

### TECHNICAL FIELD

The present disclosure relates to an around view monitor (AVM) system, and in particular, to a technology for composing images in an AVM system.

### BACKGROUND

An AVM system receives images from four cameras of the front, rear, left, and right sides of a vehicle, and composes the images into a single image to output the image to a display device. This AVM system supports eight view modes, and composes images by using a look up table (LUT) corresponding to a view mode. The generation of the LUT is briefly described as follows. Firstly, a computing device obtains standard images respectively from front/rear/left/right cameras of a vehicle, and performs an image composing simulation by using the obtained four images. Thereafter, the LUT containing coordinate and weight information of input images is generated with respect to an output image obtained through the simulation. The LUT is generated for each view mode, and is generated only for an active region of each view mode. The generated LUT is stored in a flash memory of an AVM system board. As illustrated in FIG. 1, the LUT stored in the flash memory includes records in which X, Y coordinates (X coordinate integer, Y coordinate integer) and X, Y weights (X coordinate decimal, Y coordinate decimal) are recorded. One record is used to generate one pixel image in an output image. When the one pixel image is generated, pixel interpolation is performed to adjacent four pixels for each one pixel to thereby improve image quality. This concept is illustrated in FIG. 2. Therefore, record information for one output pixel includes X, Y coordinates of an input pixel (A0) and weights of four pixels (A0 to A3).

Image composing logic is implemented by field programmable gate array (FPGA) design. The FPGA reads the LUT corresponding to a view mode determined according to vehicle communication information to generate an output image. According to the related art, a screen has one-divisional structure as illustrated in FIG. 3, or two-divisional structure as illustrated in FIG. 4. Here, the shaded block region is an active region on which an image is displayed, and the other region is a background region with black color. The output image of the active region is generated according to LUT information, and the background region is filled with black color. An example of a one-divisional-structured output image is illustrated in FIG. 5, and examples of a two-divisional-structured output image are illustrated in FIGS. 6 and 7.

According to the above-described image composing method, a type of an image to be displayed on an output screen should be predetermined according to a view mode. Further, a size of the active region and a location thereof on the screen cannot be changed. The output image may be changed according to the view mode, but this change is possible in the case of a fixed screen-dividing structure. Since a screen-dividing structure is fixed, configuration of the view mode is limited. Further, in the case of the example of FIG. 8, a left-camera image is outputted to a right side of the screen, and thus, a driver may be confused. Therefore, a structure of the view mode is required to be changed. However, according to the related art, it is needed to change the design of the FPGA. When the size or location of the active region is changed, the LUT should be changed accordingly. Further, the design of the FPGA that reads the changed LUT and generates the output image should be also changed. When the structure of the view mode is changed or a type of a vehicle is changed, the LUT and FPGA logic should be paired, causing inconvenience in version management.

### SUMMARY

Accordingly, the present disclosure provides a technology for changing a view mode and a screen-dividing structure without changing the design of image composing logic.

In one general aspect, an image composing apparatus of an around view monitor system includes an image input unit receiving images from a plurality of cameras, a storage unit storing a look up table including records in which color representation information or coordinate information of the inputted images is recorded for each screen output pixel, and an image processing unit composing images by using the stored look up table.

The image processing unit may include a look up table analysis unit analyzing a record header of the stored look up table, and a color representation processing unit extracting and outputting color representation information recorded in a data field of the analyzed record, and a camera image processing unit obtaining and outputting input image data corresponding to coordinate information recorded in the data field of the analyzed record.

In another general aspect, an image composing method of an around view monitor system includes composing images by using a look up table in which color representation information or coordinate information of input images from a plurality of cameras is recorded for each screen output pixel, and outputting the composed image to a display device.

The composing may include sequentially analyzing records included in the look up table, and extracting and outputting color representation information recorded in a data field of the analyzed record or obtaining and outputting camera input image data corresponding to coordinate information according to a header value of the analyzed record.

Other features and aspects will be apparent from the following detailed description, the drawings, and the claims.

### BRIEF DESCRIPTION OF THE DRAWINGS

FIG. 1 is a diagram illustrating a structure of an LUT record used to compose images in an AVM system according to the related art.

FIG. 2 is a conceptual diagram illustrating bilinear interpolation.

FIG. 3 illustrates an exemplary one-divisional structure of an output screen according to the related art.

FIG. 4 illustrates an exemplary two-divisional structure of an output screen according to the related art.

FIG. 5 illustrates an exemplary front image having a one-divisional structure.

FIG. 6 illustrates an exemplary front/around view image having a two-divisional structure.

FIG. 7 illustrates an exemplary front/left image having a two-divisional structure.

FIG. 8 is a diagram illustrating a basic structure of a record of a look up table according to an embodiment of the present invention.

FIG. 9 is a diagram illustrating a structure of a record for generating a black image.

FIG. 10 is a diagram illustrating a structure of a record for generating a car mask image.

FIG. 11 is a diagram illustrating a structure of a record including X, Y coordinates and X, Y weights of camera input image data.

FIG. 12 is a block diagram illustrating an image composing device for an AVM system according to an embodiment of the present invention.

FIG. 13 is a diagram illustrating a direction of generating an output pixel image.

FIG. 14 illustrates an exemplary three-divisional structure.

FIG. 15 illustrates an exemplary four-divisional structure.

FIG. 16 illustrates an exemplary output image having a three-divisional structure.

FIG. 17 illustrates an exemplary output image having a four-divisional structure.

FIG. 18 illustrates an exemplary output image having a two-divisional structure.

FIG. 19 is a flowchart illustrating an image composing method according to an embodiment of the present invention.

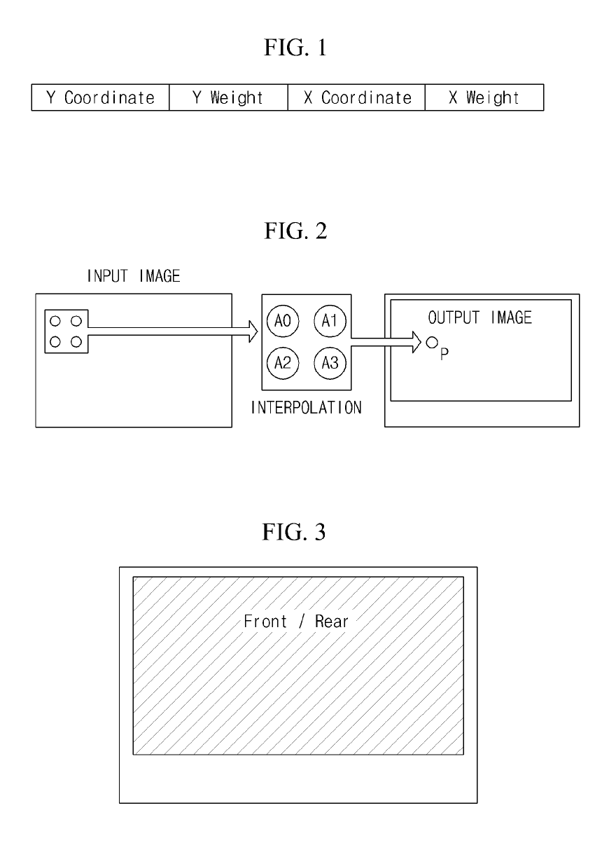

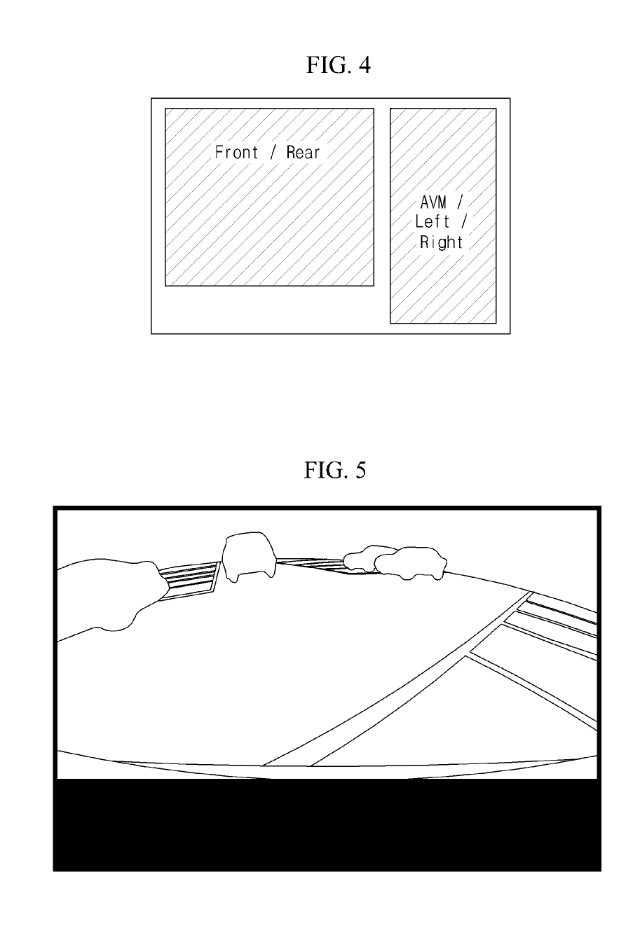

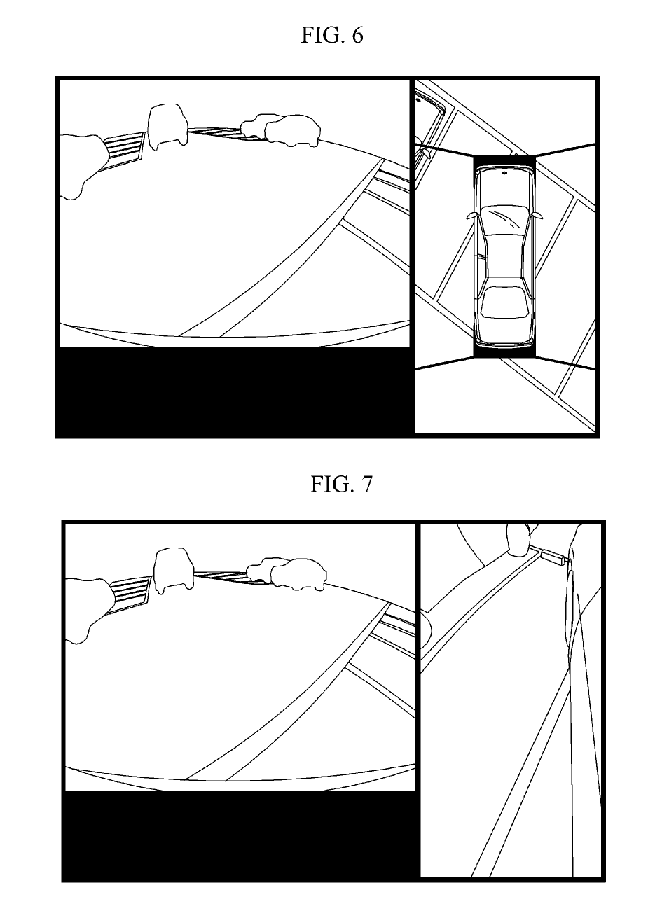

### DETAILED DESCRIPTION OF EMBODIMENTS

The above-described and additional aspects of the present invention will be clear through the preferred embodiments described with reference to the accompanying drawings. Hereinafter, the embodiments of the present invention will be described in detail so that those skilled in the art easily understand and carry out the invention.

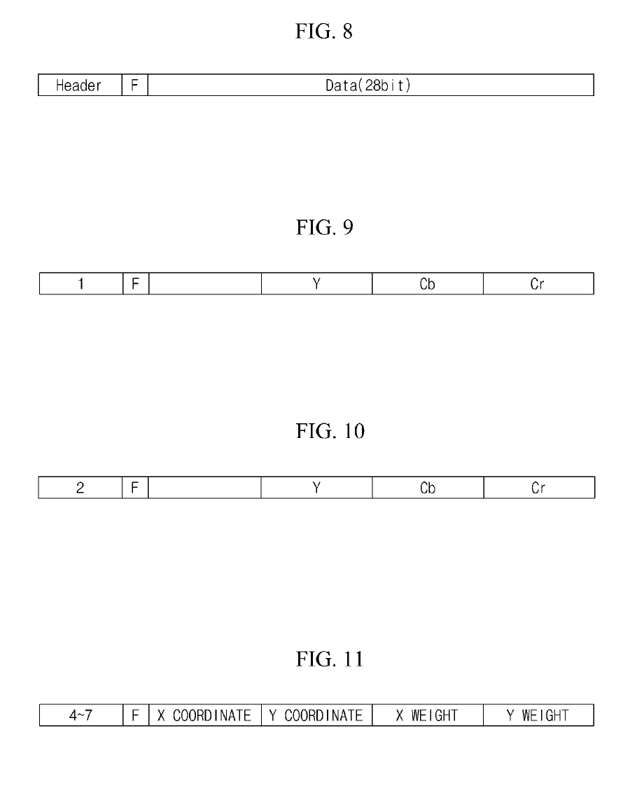

FIG. 8 illustrates a basic structure of an LUT record according to an embodiment of the present invention, FIG. 9 illustrates a record structure for generating a black image, FIG. 10 illustrates a record structure for generating a car mask image, and FIG. 11 illustrates a record structure including X, Y coordinates and X, Y weights of camera input image data.

An LUT is used to compose images in an AVM system. The LUT includes a plurality of records. One record is for one pixel of an output image. When the output image has a resolution of 720 vertical pixels by 480 horizontal pixels, the number of pixels is 345,600, and thus, the number of records of the LUT is also 345,600. A basic structure of the record is illustrated in FIG. 8. A header indicates a format for generating an output pixel or a type of input data. ‘F’ indicates field information of an input image. For reference, the ITU-R BT.656 standard is used as a transmission scheme of a camera interface, and one image (720×480) is divided into two fields (720×240) in order to be transmitted. A data field includes information for generating the output pixel. The information recorded in the data field is color representation information or coordinate information of a camera input image.

According to an embodiment, a record is divided into three types as illustrated in FIGS. 9 to 11, depending on a value recorded in the header. When the header value is ‘1’ as illustrated in FIG. 9, the information recorded in the data field is the color representation information that may be for generating a black image. Here, the color representation information may be brightness (Y) and color difference (Cb, Cr) information. When the header value is ‘2’ as illustrated in FIG. 10, the information recorded in the data field is the color representation information that may be for generating a car mask image. This color representation information may also be the brightness (Y) and color difference (Cb, Cr) information. When the header value is any one of ‘4’ to ‘7’ as illustrated in FIG. 11, the information recorded in the data field is X, Y coordinates (X coordinate integer, Y coordinate integer) and X, Y weights (X coordinate decimal, Y coordinate decimal) of camera input image data. The header value ‘4’ indicates first camera input image data, the header value ‘5’ indicates second camera input image data, the header value ‘6’ indicates third camera input image data, and the header value ‘7’ indicates fourth camera input image data. First to fourth cameras may be installed in a vehicle to capture images in different front/rear/left/right directions.

It may be understood that FIG. 9 and FIG. 10 are substantially the same. Therefore, instead of differentiating the black image and the car mask image by using different header values as illustrated in FIGS. 9 and 10, the records may be treated as one type of record by using the same header value. Or, in the case of generating color representation information for images in addition to the black image and the car mask image, types of records may be added by as much as the number of the additional images. That is, the same records as those of FIGS. 9 and 10 may be added having different head values. As described above, when the data recorded in the data fields are substantially the same but images to be represented are different from each other, the images are differentiated by using different header values, and thus, management such as image editing may be more easily performed.

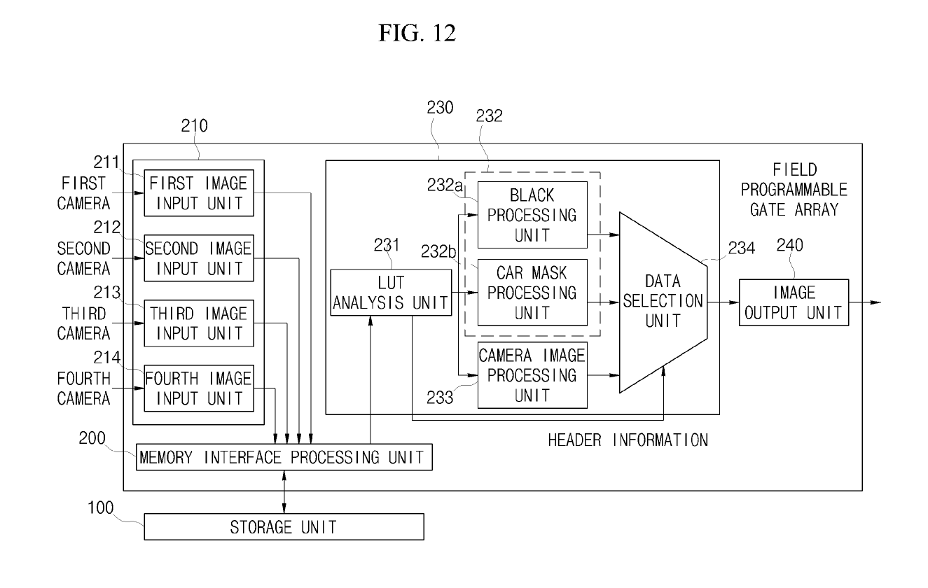

FIG. 12 is a block diagram illustrating an image composing device for an AVM system according to an embodiment of the present invention.

The illustrated image composing device is implemented in an AVM electronic control unit (ECU) and includes a storage unit 100 and an image composing unit 200. The storage unit 100, which is a memory, may include a dynamic random access memory (DRAM) and a flash memory. The above-described LUT is stored in the storage unit 100, corresponding to each view mode. The image composing unit 200 is implemented by field programmable gate array (FPGA) design, and includes an image input unit 210, an image processing unit 230, and an image output unit 240. The image input unit 210 includes a first image input unit 211 for receiving an image from a first camera, a second image input unit 212 for receiving an image from a second camera, a third image input unit 213 for receiving an image from a third camera, and a fourth image input unit 214 for receiving an image from a fourth camera. Here, although it is illustrated that the number of image input channels is four, the number may be changed according to the number of cameras. The image input unit 210 stores the inputted camera images in the storage unit 100 via a memory interface processing unit 220 that performs data read or write operations.

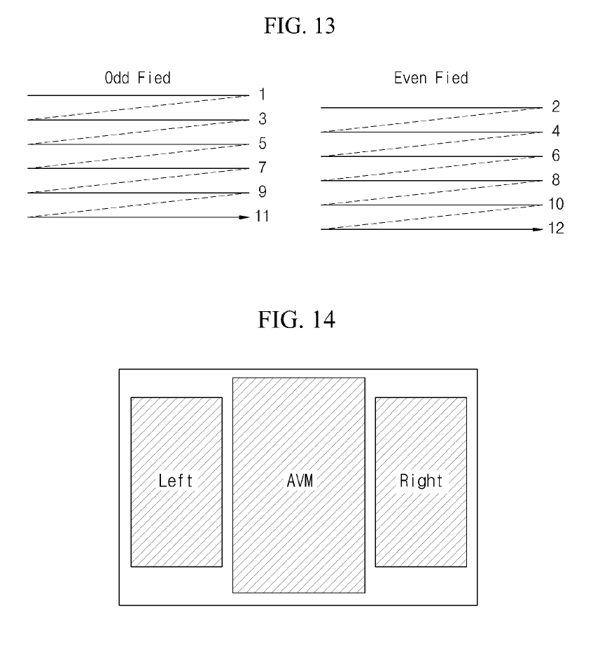

The image processing unit 230 generates an output image by using the LUT stored in the storage unit 100. The image processing unit 230 sequentially reads records from an initial record of the LUT, and sequentially generates pixel images of an output image in the output pixel image generating directions illustrated in FIG. 13. According to an embodiment, the image processing unit 230, as illustrated in FIG. 12, includes an LUT analysis unit 231, a color representation processing unit 232, a camera image processing unit 233, and a data selection unit 234. The color representation processing unit 232 may be one or more. When the color representation processing unit 232 is one, the records of FIGS. 9 and 10 are defined as one record type, and the same header value is used. When the color representation processing unit 232 is implemented as two parts, as illustrated in FIG. 12, the color representation processing unit 232 may be implemented as a black processing unit 232a for generating a black image and a car mask processing unit 232b for generating a car mask image. Hereinafter, it is assumed that the color representation processing unit 232 is implemented as two parts. Through the following description, the cases where the color representation processing unit 232 is implemented as one or three parts may also be understood.

The LUT analysis unit 231 sequentially reads records of the LUT from the storage unit 100 via the memory interface processing unit 220 in order to analyze headers. When the header value is ‘1’, the black processing unit 232a extracts and outputs YCbCr value that is black color information recorded in the data field of the record of FIG. 8. When the header value is ‘2’, the car mask processing unit 232b extracts and outputs YCbCr value that is car mask information recorded in the data field of the record of FIG. 9. When the header value is any one of ‘4’ to ‘7’, the camera image processing unit 233 obtains, i.e. reads, image data of a corresponding camera from the storage unit 100 by using the X, Y coordinates and weights recorded in the data field of the record of FIG. 11, and outputs the read data after performing bilinear interpolation. The data selection unit 234 selects one of black data of the black processing unit 232a, car mask data of the car mask processing unit 232b, and image data of the camera image processing unit 233 according to the header value transmitted from the LUT analysis unit 231, and outputs the selected data to the image output unit 240. The image output unit 240 outputs the inputted data to an external display device in an output format of the ITU-R BT.656 standard.

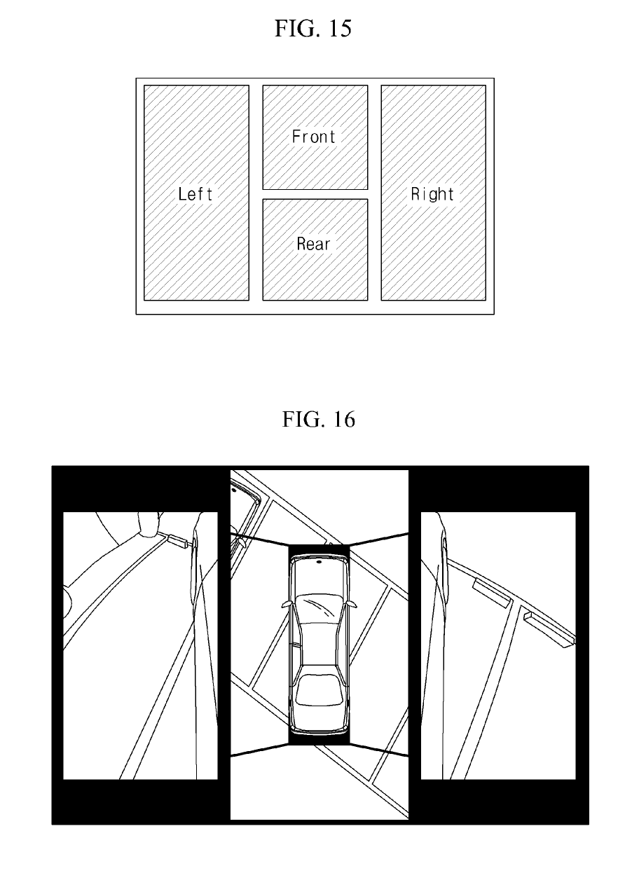

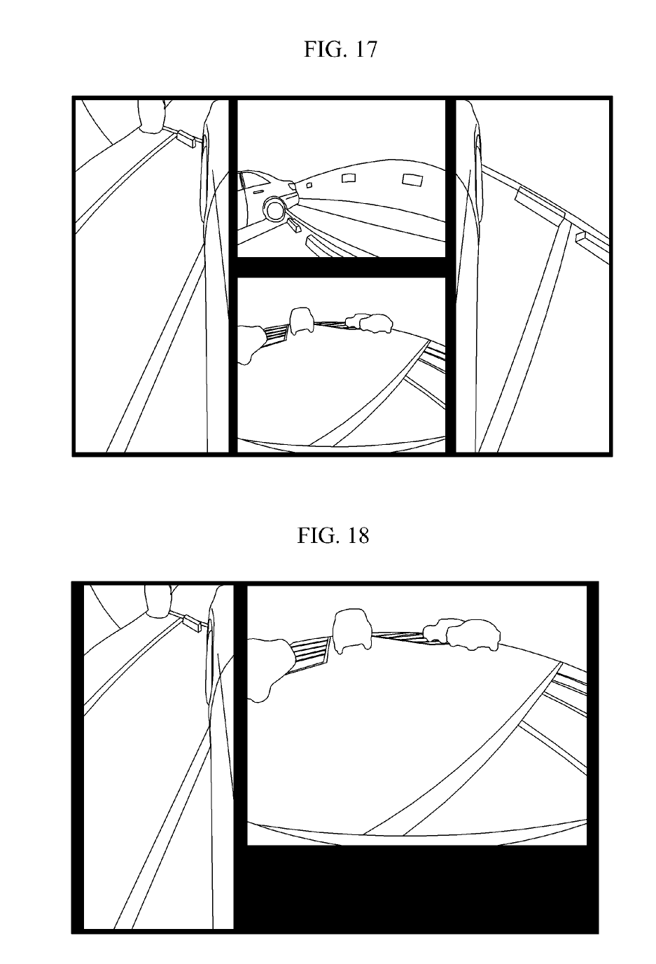

As described above, the image composing device individually processes the black image, the car mask image, and the camera image according to the header value of the LUT record. Therefore, without changing the design of the FPGA, the view mode may be freely changed by simply changing the LUT, and the view mode having three or more divisional structure is possible. For reference, the three-divisional structure is illustrated in FIG. 14, and the four-divisional structure is illustrated in FIG. 15. Here, the shaded block regions are active regions on which the car mask image and the camera image are displayed, and the other regions are background regions on which the black image is displayed. Unlike the related art, the FPGA according to the present invention generates an image not only for the active region but also for the background region by using the LUT. Therefore, without changing the design of the FPGA, an output image having the three-divisional structure may be generated as illustrated in FIG. 16, an output image having the four-divisional structure may be generated as illustrated in FIG. 17, and, as illustrated in FIG. 18, an output image may be generated so that a left image is located on a left side of a screen and a front image is located on a right side of the screen.

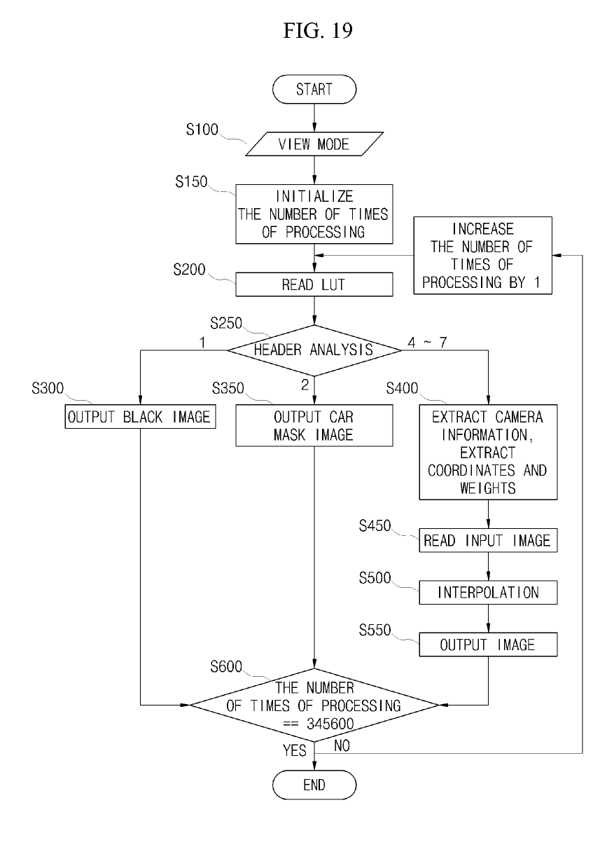

FIG. 19 is a flowchart illustrating an image composing method according to an embodiment of the present invention.

When a user selects a desired view mode via a user interface, information on the selected view mode is inputted to the AVM ECU by vehicle communication in operation S 100. The image composing unit 200 initializes the number of times of LUT processing, and sequentially reads LUT records corresponding to a determined view mode from among the LUT records stored in the storage unit 100 in operations S150 and S200. The image composing unit 200 analyzes the header of the read record in operation S250. When the header value is ‘1’, the image composing unit 200 extracts and outputs the YCbCr value recorded in the read record, which is the color representation information for the black image in operation S300. That is, black image pixel data are outputted. When the header value is ‘2’, the image composing unit 200 extracts and outputs the YCbCr value recorded in the read record, which is the color representation information for the car mask image in operation S350. That is, car mask image pixel data are outputted.

When the header value is any one of ‘4’ to ‘7’, the image composing unit 200 extracts camera information recorded in the read record and extracts X, Y coordinates and weights in operation S400. The image composing unit 200 reads corresponding image data from the storage unit 100 by using the extracted camera information, X, Y coordinates, and weights, and outputs the image data after performing well-known bilinear interpolation in operations S450, S500, and S550. Thereafter, the image composing unit 200 determines whether the number of times of processing reaches the number of pixels of the output image, i.e. 345,600, in operation S600. When the number of processing is not reached, the image composing unit 200 increases the number of processing by 1, and feeds back the number to operation S150, in operation S650.

The present invention enables a user to freely configure the view mode of the AVM system. In particular, a screen dividing structure can be changed by simply changing the LUT without changing the design of the image composing logic. Accordingly, the image composing logic can be reused, and thus, operational reliability of the system can be secured even when a vehicle is changed or needs from a user are changed.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An image composing apparatus of an around view monitor system for easily changing a view mode, comprising:
an image input unit receiving images from a plurality of cameras;
a storage unit storing a look up table including records in which color representation information or coordinate information of the inputted images is recorded for each screen output pixel; and
an image processing unit composing images by using the stored look up table.

2. The image composing apparatus of claim 1, wherein the image processing unit comprises:
a look up table analysis unit analyzing a record header of the stored look up table; and
a color representation processing unit extracting and outputting color representation information recorded in a data field of the analyzed record; and a camera image processing unit obtaining and outputting input image data corresponding to coordinate information recorded in the data field of the analyzed record.

3. The image composing apparatus of claim 2, wherein the number of the color representation processing unit is two or more, and, according to a result of the analyzing, a corresponding color representation processing unit extracts and outputs the color representation information recorded in the data field of the analyzed record.

4. The image composing apparatus of claim 3, wherein the color representation processing unit comprises:
a black processing unit generating a black image; and
a car mask processing unit generating a car mask image.

5. The image composing apparatus of claim 1, wherein the color representation information is brightness and color difference information.

6. The image composing apparatus of claim 1, wherein the storage unit stores the look up table for each view mode.

7. The image composing apparatus of any one of claims 1, wherein the image input unit and the image processing unit are implemented with a field-programmable gate array.

8. The image composing apparatus of any one of claims 2, wherein the image input unit and the image processing unit are implemented with a field-programmable gate array.

9. The image composing apparatus of any one of claims 3, wherein the image input unit and the image processing unit are implemented with a field-programmable gate array.

10. The image composing apparatus of any one of claims 4, wherein the image input unit and the image processing unit are implemented with a field-programmable gate array.

11. The image composing apparatus of any one of claims 5, wherein the image input unit and the image processing unit are implemented with a field-programmable gate array.

12. The image composing apparatus of any one of claims 6, wherein the image input unit and the image processing unit are implemented with a field-programmable gate array.

13. An image composing method of an around view monitor system for easily changing a view mode, comprising:
composing images by using a look up table in which color representation information or coordinate information of input images from a plurality of cameras is recorded for each screen output pixel; and
outputting the composed image to a display device.

14. The image composing method of claim 13, wherein the composing comprises:
sequentially analyzing records included in the look up table; and
extracting and outputting color representation information recorded in a data field of the analyzed record or obtaining and outputting camera input image data corresponding to coordinate information according to a header value of the analyzed record.

15. The image composing method of claim 13, wherein the color representation information recorded in the look up table is for generating a black image and a car mask image.

16. The image composing method of claim 14, wherein the color representation information recorded in the look up table is for generating a black image and a car mask image.
